(19) United States
(12) Patent Application Publication
(10) Pub. No.: US 2009/0216801 A1
(43) Pub. Date: Aug. 27, 2009

(54) Service Registry Document Loader

(75) Inventors: Timothy John Baldwin, Southampton (GB); John Colgrave, Hants (GB); Bernard Zdzislaw Kufluk, Southampton (GB); James Robert Magowan, Surrey (GB)

Correspondence Address: Steven E. Bach Attorney at Law, 10 Roberts Road, Newtown Square, PA, 19073, US

(73) Assignee: International Business Machines Corporation (IBM), Armonk, NY (US)

(21) Appl. No.: 12/389,840

(22) Filed: Feb. 20, 2009

(30) Foreign Application Priority Data
Feb. 25, 2008 (EP) 08151906.8

(51) Int. Cl. G06F 17/30

(52) U.S. Cl. 707/103 Z; 707/E17.055

(57) ABSTRACT

A method, system and computer program product comprising: locating an import target statement in a service document; locating a generic object associated with the service document; locating import target references; loading, when a unique import target reference is located, the located target object into an address in the repository; and resolving the source document target reference to point at this address.

The invention relates to a service registry and repository system and method, and more particularly to a service registry and repository system and method for document loading and resolving.

### BACKGROUND

Service oriented architecture (SOA) is a business-driven IT architectural approach that supports integrating a business as linked, repeatable business tasks, or services. The basic building block is a service document that defines a service so that it can be managed with other services. A service document contains information about a service including the location of the service and details about the service and how to access the service. Service documents are used by analysts, architects, and developers during a Development Phase of the SOA life cycle to locate services to reuse and to evaluate the impact of changes to service configurations. Service documents are variously described as metadata, objects, descriptions, entities and artifacts.

A service repository stores the service document and allows access to the service document and thereby the corresponding service. A service registry is an index of a subset of information about a service (for example the location and name of service document) enabling the corresponding service document to be located and accessed in a repository (or even the corresponding service located at the service provider). An integrated service registry and repository allows a service operation to use both the indexed service information in the registry and the detailed service information in the repository. An example of an integrated service registry and repository is IBM WebSphere® Registry and Repository (WSRR).

An integrated service registry and repository has advantages of greater business agility and resilience than separate systems through reuse of service documents and information. Further advantages of looser coupling, greater flexibility, better interoperability, and better governance arise from the integration. These advantages are addressed by separating service descriptions from their implementations, and using the service descriptions across the life cycle of the service. Standards-based service metadata artifacts, such as Web Service Definition Language (WSDL), extensible mark-up language (XML) schema, policy or Service Component Architecture (SCA) documents, capture the technical details of what a service can do, how it can be invoked, or what it expects other services to do. Semantic annotations and other metadata can be associated with these artifacts to offer insight to potential users of the service on how and when it can be used, and what purposes it serves.

Service documents have many formats (for instance, WSDL documents, XML policy documents, XML Schema Definition documents (XSD)) and may reference other such documents typically by an embedded import statement (literally expressed as “import” or “include”). The information provided by the import statement is defined by the XML schemas and does not provide enough information to uniquely resolve the target document from the potential matches that may be found. Suitable matches may be found from documents already stored in the central repository, from documents located elsewhere on the world-wide-web, or from documents held locally by the user. In addition, in each of these places, there may be multiple versions of the target document, and the embedded import statement provided by WSDL or XSD may not provide information to allow selection amongst such multiple versions of the same target.

One typical solution to this problem is for the repository to provide some predefined ordering from which to make its selection of target documents. This ordering may be fixed or may be customisable; however this does not provide a completely general solution to the problem and does not work very well in the situation where multiple versions of a service document exist in the same space (equivocation). Nor does it handle the case where a different target is required for two or more import statements that appear to refer to the same document (univocation). A general services repository whose pattern of use cannot be predicted needs a better and more flexible solution.

### SUMMARY OF INVENTION

According to one aspect of the invention there is provided a method of loading a service document into a service registry and repository as described in claim 1.

This embodiment uses a generic object that is stored in the repository as a container for other objects and documents that are to be stored and resolved. Such containers may themselves contain further containers in order to provide different or narrower scope for document resolution. A set of scoping rules are applied based on the container hierarchy in order to automatically resolve all document import references to the correct references.

In addition this embodiment provides a mechanism to allow easy construction of the containers and their contents, either programmatically or via a suitable user interface component. Since resolution of one import statement may lead to a further set of unresolved documents which cannot be determined ahead of time, the solution provides an iterative mechanism which continues to build the collection hierarchy that is to be used until all target references are resolved. It provides a graph structure representing the documents that are currently resolved and highlighting the nodes at which extra work is needed.

Use of the nested collection objects and associated scoping rules provides a general purpose solution to resolving document imports that does not limit or predefine the possible repository use-cases. Use of an iterative mechanism and graphical representations to build the collections provides the facilities to enable a programmatic or user-interface component to construct the necessary collection objects.

According to another embodiment of the invention, a mechanism is provided by which the correct target documents may always be selected when storing a new document into the central services repository.

### DESCRIPTION OF DRAWINGS

Embodiments of the invention will now be described, by means of example only, with reference to the accompanying drawings in which:

FIG. 1 is a schematic of service document phases in a service registry and repository according to a sample embodiment of the present invention;

FIG. 2 is a schematic of architecture of a sample embodiment of the invention;

FIG. 3 is a schematic of information architecture of a sample embodiment of the present invention;

FIG. 4 is a schematic of the document loader system of a sample embodiment of the present invention;

FIG. 5 is a schematic of process of a sample embodiment of the present invention;

FIG. 6 shows a simple successful import example according to a sample embodiment of the present invention;

FIG. 7 show the output of a successful import example; and

FIG. 8 shows the output of an unsuccessful import example.

### DESCRIPTION OF THE EMBODIMENTS

According to a sample embodiment, a service registry and repository for service documents is provided that is based on IBM WebSphere Service Registry and Repository. Such service documents include traditional internet services that use a range of protocols and are implemented according to a variety of programming models.

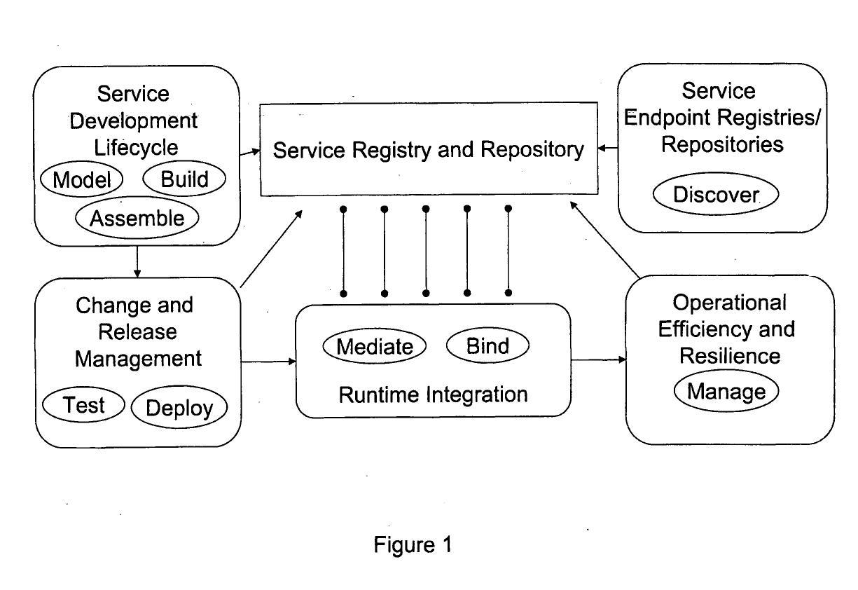

FIG. 1 illustrates service life cycle phases of the services stored as documents in the service registry and repository comprising: Service Development; Change and Release Management; and Runtime Integration and Operation. As the integration point for service metadata, the service registry and repository establishes a central point for finding and managing service metadata acquired from a number of sources, including service application deployments and other service metadata and endpoint registries and repositories. The Service Registry is where service metadata that is scattered across an enterprise is brought together to provide a single, comprehensive description of a service. Once this happens, visibility is controlled, versions are managed, proposed changes are analyzed and communicated, usage is monitored and other parts of the service architecture can access service metadata with the confidence that they have found the copy of record.

### Software Architecture

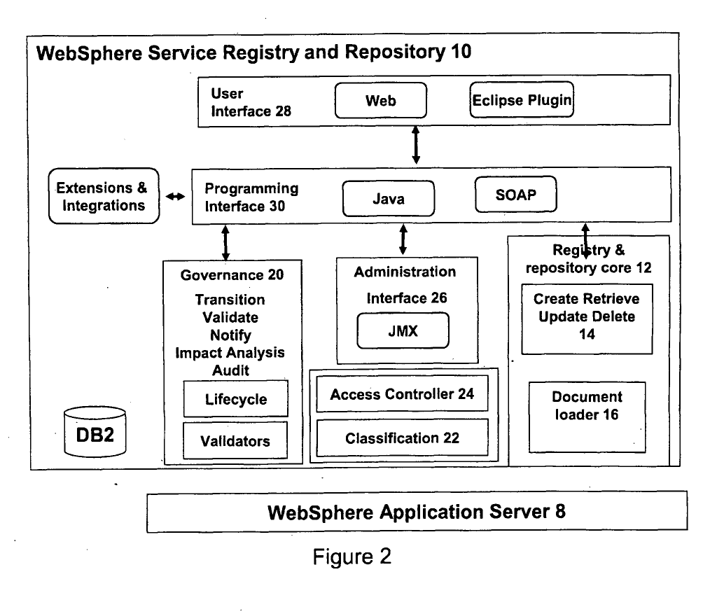

The service registry and repository of the present embodiment is a Java™ 2 Platform Enterprise Edition (J2EE) application that runs on a WebSphere Application Server 8 and uses an object database as a backing store to persist the service metadata. The service register and repository takes advantage of the role-based access control so that role-based views and access control can be turned on when the service registry and repository is deployed as an enterprise-wide application. Referring to FIG. 2, the top level components of the service registry and repository 10 comprise: a registry and repository core 12; a governor 20; an administration interface 26; a user interface 28; a programming interface 30.

The registry and repository core 12 offers both registry function and repository function for service metadata. The repository function allows users to store, manage and query service metadata artifacts holding service descriptions. It not only takes care of the documents containing service metadata by reliable persistence of the data, but it also provides a fine-grained representation of the content of those documents (for example, ports and portTypes in some service documents). The registry function makes provision for decorating registered service declarations and elements of the derived content models with user-defined properties, relationships, and classifiers. The registry and repository core provides a rich query interface 14 that makes use of those decorations when a search is performed to find entities such as a service endpoint or service interface.

Whenever a change to registry or repository content is detected by the registry and repository core, it invokes all validation and notification functions that are registered in the validation register 16 and the notification register 16. Both kinds of functions are considered extension mechanisms that can be used to customize how the service registry and repository reacts to changes. A validation function can be written and registered so that the registry and repository core will execute when changes are made to the content. For example, a validation function that checks for completeness of a service definition. The registry and repository core includes a notification plug-in (not shown) with a subscription capability for a notification communicating a change in the content of the service registry and repository.

Through the governor 14, the service registry and repository supports a rich set of extensible governance functions, including the ability to model a service life cycle model for governed entities, define valid transitions between service states, write and plug-in validators to guard the transitions between states, and designate (notification) actions to be taken as result of the transition. It also provides interfaces to analyze the impact of changes to content, and provides auditing of such changes.

The classification component 22 allows service descriptions and parts of service definitions to be annotated with corporate vocabulary and to capture the governance state. Service classification systems are captured in web ontology language (OWL) documents that are loaded into the Service Registry and Repository using the administrative interface. Service registry and repository entities can be classified with values from these classification systems, to allow classification-based queries to be performed, and to allow access restrictions based on classification.

The access controller 24 supports a fine-grained access control model that allows for the definition of which user roles can perform specific types of actions on corresponding artifacts. Visibility of services can be restricted by business area and user roles can be restricted from transitioning services to certain life cycle states. This is in addition to the role-based access control provided by the service registry and repository.

The administration interface 26 supports the import and export of repository content for exchange with other repositories and provides an API for configuration and basic administration. These support interactions with the Access Controller and with the Classifier.

User interface 28 comprises a web interface and an eclipse plug-in interface to enable interaction with service registry and repository. A servlet based web user interface (UI) supports is the main way for users representing different roles to interact with the service registry and repository. The web interface supports all user roles, offering lookup, browse, retrieve, publish, and annotate capabilities, as well as governance activities, such as import/export and impact analysis. A subset of this user interface is offered as an Eclipse plug-in to meet developer needs and analyst users needs that use Eclipse based-tooling. The Eclipse plug-in is used primarily for lookup, browse, retrieve and publish capabilities. The Web-based user interface can also be used for performing service metadata management and governance.

Programming interface 30 uses Java and SOAP (Service Oriented Architecture Protocol) APIs to interact programmatically with registry and repository core 12. These APIs provide basic create, retrieve, update and delete (CRUD) operations, governance operations, and a flexible query capability. The SOAP API is used to communicate content using XML data structures. The Java API is used to communicate content using service data object (SDO) graphs. Using either the user interface 30 or the programming interface 28, documents and concepts managed by WSRR can be created, retrieved, updated and deleted. However, logical entities in the logical model cannot be modified and these can only be changed by updating a document that contains the logical entity. Concepts can be created, retrieved and deleted.

The service registry and repository of the present embodiment supports two application programming interfaces (APIs) that can be used to interact with the registry and repository core 12; the governance component 20 and the administration interface 26: a Java-based API and a SOAP-based API respectively. Both APIs support publishing (creating and updating) service metadata artifacts and metadata associated with those artifacts, retrieving service metadata artifacts, deleting the artifacts and their metadata, and querying the content of the registry and repository. The programming APIs use Service Data Objects (SDO) to capture the data graphs inherent in the content model, allowing access to physical documents, logical parts of the physical documents, and concepts. The SOAP API uses XML documents to similarly represent Service Data Objects to communicate content structures in both the physical and logical model.

Path query expressions are used to perform searches with the query interface 14 for coarse- and fine-grained queries. Queries can be performed using semantic annotations, properties, and all or parts of physical service metadata artifacts. Fragments of metadata may be returned (such as endpoints), all metadata may be returned, and both metadata and documents may be returned. In addition to “free-form” path based queries, a set of pre-canned queries are available to use to address common paths through the WSRR content model. A path expression identifies the type of managed entity to be returned and filters that capture the managed elements related to the desired object. Extensions are provided to include classification annotations in a query. For example, if the search is for all WSDLServices that have a port that refers to a binding that refers to a portType named “StockQuotePortType”, the following query expression would be used:

/WSRR/WSDLService[port/binding/portType/@name=‘StockQuotePortType’];

The governor 20 allows analysis of the impact of changes to specific artifacts through an API. A set of predefined impact queries is available to help a user to navigate through the registry and repository content according to popular patterns, such as which WSDL files import or use this XSD. In addition one can use Governance operations to request life cycle transitions for a governed entity as well as the configuration of e-mail notifications for users interested in specific content changes.

The administration interface 26 provides an administration API that supports basic configuration and loading and managing of metadata in support of repository content, such as classification and life cycle management. The administration API allows a user to load definitions of state machines to be used to model the life cycle of governed entities, and to load classification systems described in OWL. In addition, the administration API supports registration of plug-ins for validation functions or additional notification functions.

### Information Architecture

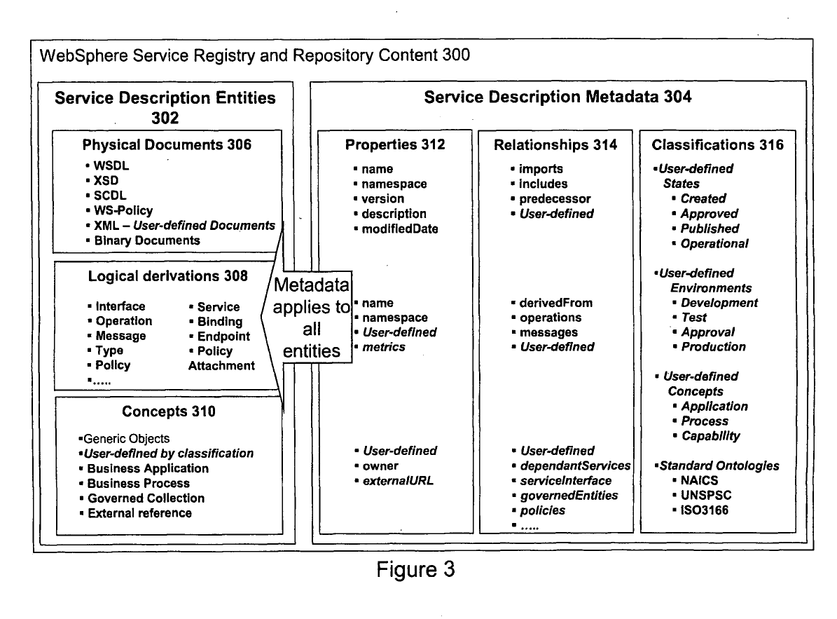

Referring to FIG. 3, an informal description of Information Architecture 300 is provided. Broadly, information architecture 300 has entities representing service description entities 302 and service description metadata 304. All artifacts have an assigned URI (uniform resource identifier), a name and a description. Examples of various types of artifacts are shown in FIG. 3 but are not necessarily referred to in the description.

Service Description Entities 302 comprise physical documents 306; logical derivations 308 and concepts 310. Physical Documents 306 are XML documents that are known as service metadata artifacts. Logical derivations 308 are the finer-grained pieces of content that result when some types of physical document are shredded as they are loaded into Registry and Repository. Concepts 310 are generic entities that are usually typed, and represent anything that is not represented by a document in Registry and Repository. All three types of service description entities can be use in queries, have service annotations applied, and have relationships established from and to them.

The most elemental building blocks for the WSRR are the physical documents 306 such as XSD, WSDL, SCDL or WS-Policy documents. In addition any XML service metadata artifact type or binary document can be stored in WSRR and receive the benefits of broader visibility, reuse, management, and governance. The coarse-grained model made up from registry objects that represents those documents is referred to as the physical model. Documents are versionable objects in the WSRR content model, which means that in addition to a URI, name, and description, they also have a version property.

For some of the physical document types, WSRR derives logical objects and stores them in logical derivations 308. For instance, WSRR can “shred” a document upon receipt into a set of logical objects to enable users to explore WSRR content beyond the boundaries of the files stored. Logical objects are not versionable. For some physical document types, WSRR defines a predefined set of properties and detects relationships to other physical documents. An XSD document, for example, has a target Namespace property and the relationships with other imported XSD documents, other redefined XSD documents and other included XSD documents. When an entry for a certain physical document is created in WSRR, it is introspected for relationships to other artifacts. If not already represented in WSRR, a related artifact is also added, and in either case the relationship between the artifacts is recorded.

The set of logical derivations comprises the logical model of WSRR. The logical model has entities such as portType, port, and message related to WSDL files, and complexType or simpleType related to XSD documents. Elements of the logical model have properties and relationships reflecting a subset of their characteristics as defined in the underlying document. For example, a WSDLService element has a namespace property and a relationship to the ports it contains. It is important to note that all individual results of document shredding are aggregated into one logical model that represents not only the content of individual documents, but also relationships between content in different documents.

WSRR stores other types of service metadata using the XML Document, a generic document type. Documents of type XML Document are not decomposed into the logical model.

WSRR uses a concept to represent anything that does not have a physical document. Concepts 310 are used to represent a reference to content in some other metadata repository, such as a portlet in a portlet catalogue or an asset in an asset repository. It can also be used to group physical artifacts together to govern them as a unit; for example, concepts can be versioned.

In addition to content directly related to entities 302, WSRR supports a number of metadata types that are used to describe entities 302. These metadata types are referred to as service description metadata 304. WSRR supports three types of service semantic metadata types: properties 312; relationships 314; and classifications 316. All three types describe physical model entities, logical model entities, and/or concepts. For example, service description metadata can be used to associate a property “businessValue” with a physical model entity representing a WSDL file. It might also be used to define a new relationship “makesUseOf” between an entity in the logical model representing a “portType” and an entity in the physical model representing an XML document. Furthermore one could create a classification of “importantThings” and associate it with a “port” entity in the logical model and with an entity in the physical model representing a “Policy” document. This enables semantic queries to target individual elements of the service metadata, and meaningful dependency analyses to take place prior to making changes.

Properties 312 are simple name/value pairs that are associated with any of the Service Description Entities 302. Some properties are assigned by the system, such as the unique id, the owner, and the last time the service entity was changed. These system-assigned properties cannot be changed. Others are derived through the “shredding” of a key-type service description document into its logical model. Properties of this type include name and namespace. Sometimes these system-assigned values are allowed to be changed and properties can be created. Such a user-defined property can be used as a simple, unstructured and untyped extension mechanism. Properties 312 can be used in queries, and can be used to establish fine-grained access control.

Relationships 314 tie together one source service description entity to one or more target service description entities. Every relationship is given a name and a source is only allowed to have a single relationship with a given name. Some relationships are assigned by WSRR during the “shredding” of key types of documents. The relationship established between XSD documents based on the importing of one into the other is one such system-assigned relationship. Relationships can also be user defined. For example, a user can: relate a concept that represents an external object to a service using a user defined relationship; relate all of the service description documents that will be governed as a unit to a governable entity; and/or relate a monitoring policy to a service endpoint.

A user can load classifications 316 into registry 300 where they can then be used to apply semantic meaning to service description entities 302. Classification systems are documents encoded using the Web Ontology Language (OWL). The registry represents OWL Classes as classifiers and interprets the subTypeOf relationship between those Classes as establishing a classifier hierarchy. Other OWL concepts such as data or relationship representing properties or other built-in OWL relationships are ignored. A classification system is imported into the registry as a whole and updates are made by importing a modified version of the ontology. Any class in the underlying ontology can be used as a classification; the same classification can be used to classify multiple entities and an entity can be associated with multiple classifications.

### Document Loader

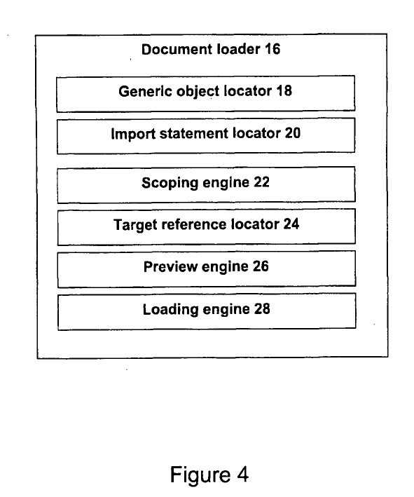

Referring to FIG. 4 there is shown a service document loader 16 according to a sample embodiment comprising: generic object locator 18; import statement locator 20; scoping engine 22; target reference locator 24; preview engine 26; and loading engine 28.

Generic object locator 18 is for locating a generic object associated with the service document to be loaded. A generic object is a first class object in the registry, which has many of the same properties as a document. A generic object can be used to group objects such as documents together into collections. Generic objects themselves can be included in collections to establish a smaller limited scope inside that of the parent GenericObject.

Import statement locator 20 is for parsing the service document to find a document import statement and for identifying the object names for importing.

Scoping engine 22 is for identifying the scope of the search for the target objects from amongst one or more of: the repository; a path identified by the generic object; and one or more secondary locations.

Target reference locator 24 is for locating one or more target references using the scope defined by the scoping engine.

Preview engine 26 is for displaying to a user the one or more target references.

Loading engine 28 is for loading a target reference into the repository when there is a single target reference and for resolving the link from the source document to the target document. When there is more than one target reference, then it is left to the user to define a specific target reference in the generic object or to narrow the scope of the scoping rules.

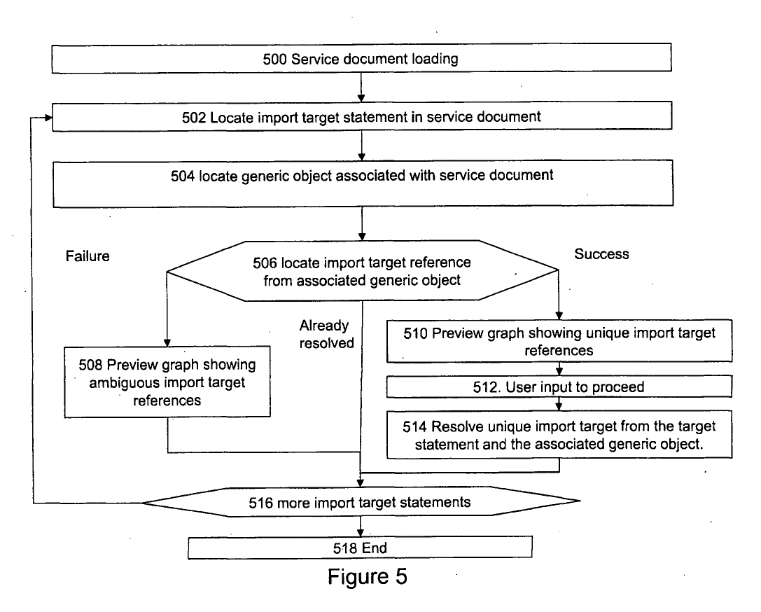

Referring to FIG. 5, there is shown a method flow 500 of the document loader 16 for loading and resolving a service document according to a sample embodiment of the invention.

Step 502 is one of locating an import target statement in a service document. For example, a target statement is located when the service and registry core scans a service document, triggering the method flow 500. Embodiments of this invention apply where an import target statement exists in a service document.

Step 504 is one of locating a generic object associated with a service document. In the registry and repository, a generic object is expected whenever there is an import statement.

Step 506 is one of locating import target references defined by a scope for that target in the generic object. The scope is one or more of: a particular path defined by the generic object; the whole repository; and one or more secondary locations. When the search has finished, then the method proceeds in one of three different ways depending on the search results. If no or more than one target reference object is located then the import is categorized a “failure” and the process moves to step 508. If a unique target reference is located then the import is categorized a “success” and the process moves to step 510. If the target reference is already loaded and resolved then the process moves straight to step 516.

Step 508 is taken if more than one target reference is found. This can happen if there are more than one version of the target object in the repository, such as the generic object path and other secondary locations. The results of the search are previewed in graph form for the user to understand way the loading and resolution has failed. Then, the process moves on to step 516.

Sep 510 is an optional step taken if a unique import target is found. The results of the search are previewed in graph form for the user to see the object that will be loaded and resolved.

Step 512 is another optional step where the process is waiting for user confirmation to proceed.

Step 514 loads the located target object into an address in the repository and resolves the source document target reference to point at this address.

Step 516 is one of checking the service document for more import target statements and iterating around the whole process re-starting at step 502.

Step 518 is one of ending the process when there are no more import target statements. The user has a chance to update the target statements, the generic object or the scoping rules and then re-execute the method in an attempt to successfully import the failed imports.

### EXAMPLE

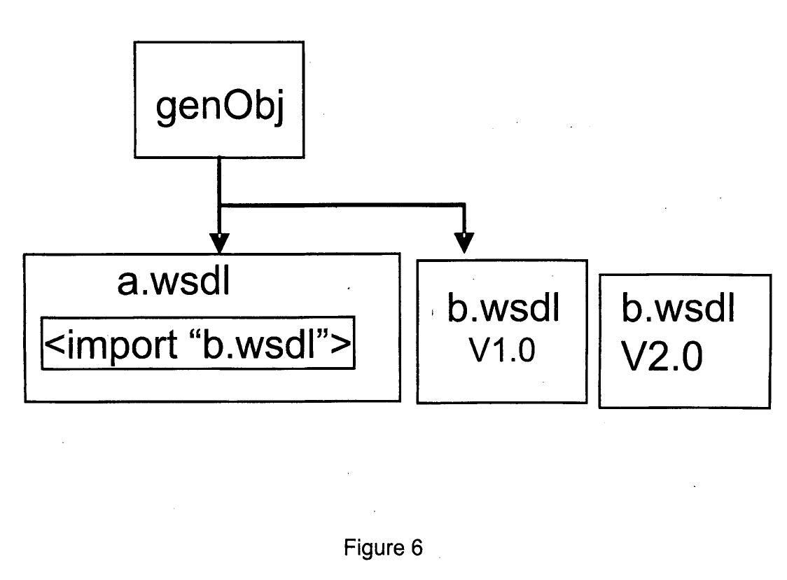

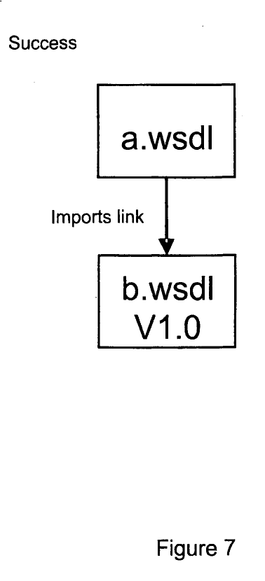

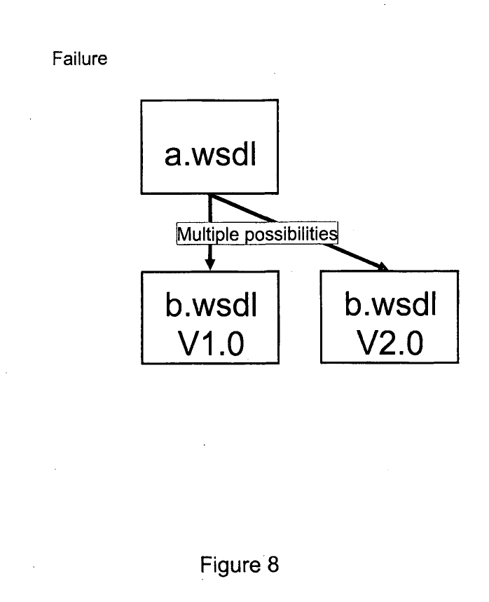

A simple successful import is described with reference to FIGS. 6 and 7 and a simple unsuccessful import or failed import is described with reference to FIG. 8.

With respect to the successful import example, Document A (called a.wsdl in service notation) uses the standard wsdl import mechanism to include another Document B (called b.wsdl in service notation). Document A contains the statement:

<import“b.wsdl”>

Document B exists in two forms in the repository, both called b.wsdl but with different versions (v1.0 and v2.0). GenericObject (referenced genObj in FIG. 6) associates a.wsdl and b.wsdl v1.0. When a user passes Document A through the method 500 where GenObj points to the b.wsdl v1.0, then a preview graph like FIG. 7 is generated showing that the resolution is a success and that a.wsdl will import b.wsdl v1.0.

An unsuccessful import example will be like FIG. 6 but without the General Object GenObj. Since nothing points to a unique version of b.wsdl, then the resolution will be a failure and a graph similar to FIG. 8 will be rendered. More complicated examples would comprise multiple dependent documents.

### Other Embodiments

It will be clear to one of ordinary skill in the art that all or part of the method of the preferred embodiments of the present invention may suitably and usefully be embodied in a logic apparatus, or a plurality of logic apparatus, comprising logic elements arranged to perform the steps of the method and that such logic elements may comprise hardware components, firmware components or a combination thereof.

It will be equally clear to one of skill in the art that all or part of a logic arrangement according to the preferred embodiments of the present invention may suitably be embodied in a logic apparatus comprising logic elements to perform the steps of the method, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

It will be appreciated that the method and arrangement described above may also suitably be carried out fully or partially in software running on one or more processors (not shown in the figures), and that the software may be provided in the form of one or more computer program elements carried on any suitable data-carrier (also not shown in the figures) such as a magnetic or optical disk or the like. Channels for the transmission of data may likewise comprise storage media of all descriptions as well as signal-carrying media, such as wired or wireless signal-carrying media.

The present invention may further suitably be embodied as a computer program product for use with a computer system. Such an implementation may comprise a series of computer-readable instructions either fixed on a tangible medium, such as a computer readable medium, for example, diskette, CD-ROM, ROM, or hard disk, or transmittable to a computer system, using a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink-wrapped software, pre-loaded with a computer system, for example, on a system ROM or fixed disk, or distributed from a server or electronic bulletin board over a network, for example, the Internet or World Wide Web.

An alternative embodiment of the present invention may be realized in the form of a computer implemented method of deploying a service comprising steps of deploying computer program code operable to cause the computer system to perform all the steps of the method when deployed into a computer infrastructure and executed thereon.

A further alternative embodiment of the present invention may be realized in the form of a data carrier having functional data thereon, said functional data comprising functional computer data structures to enable said computer system to perform all the steps of the method when loaded into a computer system and operated upon thereby.

It will be clear to one skilled in the art that many improvements and modifications can be made to the foregoing exemplary embodiment without departing from the scope of the present invention.

1. A method for loading and resolving a service document comprising:
locating an import target statement in the service document;
locating a generic object associated with the service document;
locating import target references;
loading, when a unique import target reference is located, the located target object into an address in the repository; and
resolving the source document target reference to point at the address.

2. A method according to claim 1 wherein, if more than one target reference object is located then creating a graph of the multiple target reference objects.

3. A method according to claim 1 wherein, if a unique import target is found, then generating a graph of the object that will be loaded and resolved.

4. A method according to claim 3 further comprising, waiting for user confirmation before proceeding to load and resolve the unique import target.

5. A method according to claim 1 further comprising checking the service document for subsequent import target statements and iterating the process for each subsequent import target statement.

6. A system for loading and resolving a service document comprising:
means for locating an import target statement in the service document;
means for locating a generic object associated with the service document;
means for locating import target references;
means for loading, when a unique import target reference is located, the located target object into an address in the repository; and
means for resolving the source document target reference to point at the address.

7. A system according to claim 6, further comprising means for creating a graph of the multiple target reference objects if more than one target reference object is located then.

8. A system according to claim 1, further comprising means for wherein generating a graph of the object that will be loaded and resolved, if a unique import target is found.

9. A system according to claim 8 further comprising means for waiting for user confirmation before proceeding to load and resolve the unique import target.

10. A system according to claim 6 further comprising means for checking the service document for subsequent import target statements and iterating the process for each subsequent import target statement.

11. A computer program product comprising a computer readable medium having computer readable code stored thereon for loading and resolving a service document, said computer readable code being configured when loaded onto a computer system and executed to:
locate an import target statement in the service document;
locate a generic object associated with the service document;
locate import target references;
load, when a unique import target reference is located, the located target object into an address in the repository; and
resolve the source document target reference to point at this address.

12. A computer program product according to claim 11 wherein, if more than one target reference object is located, then creating a graph of the multiple target reference objects.

13. A computer program product according to claim 11 wherein, if a unique import target is found, then generating a graph of the object that will be loaded and resolved.

14. A computer program product according to claim 13 further comprising, waiting for user confirmation before proceeding to load and resolve the unique import target.

15. A computer program product according to claim 11 further comprising checking the service document for subsequent import target statements and iterating the process for each subsequent import target statement.
